(19) United States
(12) Patent Application Publication
(10) Pub. No.: US 2022/0374921 A1
(43) Pub. Date: Nov. 24, 2022

(54) METHOD FOR TRACKING LIFETIME VALUE OF ON-LINE CUSTOMERS USING SIMPLE EMAIL ADDRESS AND INTERNET PROTOCOL DATA

(71) Applicant: Wicked Reports, LLC, Marblehead, MA (US)

(72) Inventor: Scott Desgrosseilliers, Marblehead, MA (US)

(73) Assignee: Wicked Reports, LLC, Marblehead, MA (US)

(21) Appl. No.: 17/817,982

(22) Filed: Aug. 6, 2022

Related U.S. Application Data
(63) Continuation of application No. 15/723,037, filed on Oct. 2, 2017.
(60) Provisional application No. 62/403,316, filed on Oct. 3, 2016.

(51) Int. Cl. G06Q 30/02; G06Q 30/00; G06Q 30/06

(52) U.S. Cl. CPC G06Q 30/0201; G06Q 30/01; G06Q 30/0633

(57) ABSTRACT

The present invention provides a method of taking information typically provided by web users to web owners, and uses that information to help track the value of a contact and pinpoint the genesis of the source of the value and then track the lifetime value of that customer going forward. In a preferred embodiment, the information is an email address, information often provided by web user when purchasing or securing information from a web site and the time that the email was forwarded by a link click in the Internet. In addition, location of the link and the use of a system provided by a web based marketing analysis company that provides subscription based actionable reports on marketing results, or the like, provides the user with the lifetime value of the customer, ROI and other data on its CRM. The data on value is provided on a daily basis, or as often as desired, to the user in the form of reports showing market analysis parameters.

### FIELD OF THE INVENTION

The present invention concerns commerce data from any source including Internet web pages and other advertisement sources. More particularly the present invention concerns the automatic tracking of lifetime value of a customer including the event and date that the person became a customer via the customer email and Internet Protocol data without the need for any manual intervention or interpretation of data by the user of the invention.

### BACKGROUND OF THE INVENTION

Internet commerce is a major force in the economies of most companies in many nations, and while its beginnings were fundamentally unregulated and the course of business was un-trackable such that the value of actions thereon where not understood or re-creatable, certain strides have been made to make Internet commerce better understood and therefore easier to use and quantify. Such strides have included a plethora of computer programs and suites that allow web commerce site owners, by entering data reflective of the customer's uses and practices on their web sites, to parse the expenses and values of the particular Internet business. Most of these prior methods require the user to continually enter data into the systems in order for those systems to produce metrics to understand and categorize the business.

The current problem faced by small and medium size businesses is that users are not able to determine where its customers are from. Accordingly, users cannot determine what the true ROI, LTV, EPC, or CAC values are and therefore cannot confidently scale and optimize its marketing. Existing solutions, for web site marketing performance analysis, typically only track the “last click” attribution, which tells users what was the last online click before a purchase. However, such solutions do not identify from where the customer came and cannot tell a user where it should spend its time and money marketing to the target customers. This is because most customers go through a number of ad impressions, clicks, emails, and other mechanisms until they end up becoming a customer. It is rare that a business can show an ad to a potential customer that has never heard of that business before, and suddenly convert them instantly to become a customer. It takes time, which time is called the customer journey, and that journey must be tracked over time in order for a business to make intelligent decisions on how they truly acquired their customers.

Further, existing solutions and prior systems rely on cookies, conversion programs installed, visits to thank you pages, or require specific user behaviors after purchases to provide similar financial and marketing information and are complex or require continued entry of such information. Other solutions need to have specific links built into databases before they can be used for marketing, and/or require IT work done by the businesses to store and map data, and/or often fail, as is known by persons having ordinary skill in the art, when there are multiple domains involved in the lead capture process.

Additionally, the learning process for the users of prior methods is much more complex and can involve one or more of the following steps. First, the user of a prior method typically must create unique landing pages for each different online advertisement that it places on its web site. The user must then create unique tracking links for each different online advertisement that point to each unique landing page. Next, the user must write or buy code that retrieves the unique tracking link information. The user must then create hidden HTML form fields to store the unique tracking link information that the code retrieves from the link. The user then must insert the hidden form fields to a CRM or database along with the user identifying information. Customer and link identifying information must then be exported from a database or other location to the system. Next, the user must create lookup tables for the link identification information, and must have the expertise to know what type of information is needed to maximize its marketing ROI when the information is received. The lookup tables must then be used to map the existing link ID with the detailed link information, which ultimately identifies the time of the data capture.

One of the fundamental flaws in the present metric measurement systems is that they fail to recognize the importance of the genesis of the commerce—that first element that caused a person to come to a website and make a purchase as well as those elements of the site that have kept the client returning, and to use the source of that commerce to track every event that follows.

It is therefore an object of the present invention to provide a means for determining the value of an ecommerce contact for the entire life of the customer from the first incident of interest in the vendor. It is another object that the tracking be done with precision based on very few metrics and with little outside software need, so as to lower costs and guarantee accuracy. An object of the invention is to track the lifetime value of a customer by its email and Internet Protocol (IP) addresses so as to be able to update costs and revenues from that client automatically, without the need for additional components, manual entries by the user or additional software

Other objects and advantages of the present invention will become apparent as the description proceeds.

### SUMMARY OF THE INVENTION

In accordance with the present invention, a method of tracking, analyzing and reporting the value, and most importantly the lifetime value (LTV), of an Internet customer and the genesis of such value to an advertising effort or a social media post is provided. The method includes the steps of searching a computer based web page click data for specific information and actions; maintaining a computer database of specific information and actions for comparison to new specific information and actions received from web page click data; comparing newly received web page click data against that stored in the database to determine which was the most recent web page click data in time to a specific action, such as the date and time that the page visitor subscribes to a business' email list and labeling that click data “first optin”; tracking all click data and associated functions related to any click data and associating such with the “first optin”; and reporting information as to customer value based on “first optin” and all associated clicks after the “first optin” by analyzing and manipulating all tracked click data and connecting all relevant costs from advertising platforms back to this first optin point for the purposes of ROI, customer lifetime value (LTV), revenue, and other marketing performance measures

In a preferred embodiment, the method of tracking is completed automatically in a computer and the specific information comprises an email address and the date it was received, such that in the system, the email address is compared to a database to deteiiiiine whether the email address has been previously received and if not, the email address and date received is labeled “first optin”. In some embodiment, the specific information includes the social media web site from which the click arrived such that tracking of purchases from such sites is possible.

It will be understood by persons having ordinary skill in the art that a computer, as noted herein, will include at least one of each of a microprocessor, a storage drive or other means to store and retrieve data, random access memory (RAM), an operating system (OS) and read only memory (ROM); additionally the computer, using its operating system in conjunction with software related to the operation of the present invention, will have means to access other computers and/or the Internet and means for a user to enter data and retrieve data, including some visual aid, such as a display monitor; software to run the applications associated with the present invention are extant there-within the computer. The computer used in the present invention will be capable, as programmed to enter and store information, manipulate and re-store information as demanded by the software or by the users thereof; and to produce for use and manipulation, data and results, for re-entry into the computer for further manipulation or for immediate use by the user of the present invention.

In the preferred embodiment tracking is done by a link tracking identifier script and the web page owner includes specific link information in the in the URL of its web pages. The database in such embodiments includes a Customer Relations Manager (CRM) and the link data is compared with data within the CRM. Further, in comparison of email data, if an email address is received that is already in the CRM it is labeled “re-optin”. In the preferred embodiment information tracked by the method is reported periodically and on demand.

In a specific use of the present invention, a method of tracking, analyzing and reporting the value of an Internet customer and the genesis of such value to a web page, using a computer, is provided and the method includes the steps of searching a computer based web page click data for the email address of a customer and the date and time the email address was entered; maintaining a computer Customer Relations Manager database (CRM) having at least email addresses of customers and associated purchases of customers, for comparison to new email addresses and date and time data received from web page click data; comparing newly received email addresses against those stored in the database to determine which was the most recent web-page click in time to a purchase and labeling that click data “first optin”; tracking all click data and associated purchases related to any click data and associating such with the “first optin” using link tracking scripts; and reporting information as to customer value based on “first optin” and all associated clicks after the “first optin” by analyzing and manipulating all tracked click data and placing it is a readily understandable table and connecting all relevant costs from advertising platforms back to this first optin point for the purposes of ROI, LTV, Revenue, and other marketing performance measures. Many of the parameters noted above are useable in the present embodiment.

In one form, the current invention involves tracking lifetime customer value by email and IP and the method for doing this. The current invention functions without the need for direct integration between the Customer Relationship Management system (CRM) and the web analytics platform. Rather, it ties the emails and Internet Protocol address (IP) clicks to the email holder's activity in the CRM and order systems. This provides a number of benefits to the user of the invention. For instance, the user can connect advertising (or ad), social, and email clicks and costs, to its immediate and future sales, without needing a programmer or requiring information to be inserted into the CRM to connect the marketing to the sale, so that the metrics are correctly recorded for later tracking of value based on advertising and other elements. Additionally, the lifetime value number is guaranteed to be accurate because the method of the present invention takes the sales numbers from the CRM and gives credit to only one link click for each sales attribution model. Moreover, users can, based on the data captured in the present method, see the exact orders that make up a specific link's lifetime value amount, as well as information on who made the click, when they clicked, what they clicked on, and all future orders that occurred from that point.

The focus on measuring the results of advertising depends on the contact's first opt-in to the user's web presence and tracking all relevant activity surrounding the opt-in, which has been named, here as “First optin tracking”. First optin tracking describes the association of a purchase to a CRM creation event, without pixels, post purchase customer actions, or post purchase specific page loads as in the past, but instead by using the email address detected in an incoming link click, the date and time of the link click, the date and time of the CRM record creation, the email address detected when input on a web page, and the email address of a future purchase when detected.

To summarize the process then, the present invention teaches users how to connect links with the invention's proprietary link tracking identifier. Users can add the invention's link information directly to the end of its Internet web site link, and there is no need thereafter to build an internal link that must then be copied into the user's advertisements or ads, as in prior tracking methods. Once this first step is completed then, a click tracker script is placed on the user's various web properties, including its web domains, landing page software applications, funnel applications, and lead capture applications. The invention then automatically captures IP addresses, link tracking identifiers, the time of the click, and email addresses that are entered or known on the particular page. Data can be pulled on a daily basis, or at any rate desired by the user, from the ad platforms; the data contain the cost, clicks, and the link tracking identifiers for every ad link. Additionally, all contact information, including create date of the contact, email address, and all order information by email address including the time and date of the order, is pulled daily from the CRM by the present inventive process. The process then matches up the contact creation times and order times with the particular click of the customer's that is most proximate in time. This information then provides data to determine the exact click that led to the contact joining someone's email list as well as which click led to the sale.

The process concurrently measures and tracks lifetime revenue based on four key click points, including: the first click that the system ever captured from a particular contact, called “first click”; the last click prior to the contact joining the email list, called “first optin”; the last click prior to the sale occurring to that contact, within 24 hours (or, as will be known to persons having ordinary skill in the art, any relevant time period as determined by the user and or the needs of the user), called “converting click”; and, the last click wherein a contact provided an email address; where if that contact already existed in the email list, called “re optin”. Data on the entire click history for the above four points, and the lifetime revenue and Return On Investment (ROI) (revenue-costs/costs) for that link click is, in the preferred embodiment, measured daily. As the contact moves forward in the sales processes, the ROI and Lifetime value is updated when the link becomes more valuable. The present process of tracking lifetime customer value by email and IP and the method for it provides the ability to update costs and revenue automatically, without the need for additional components or manual entries by the user.

It will be understood by persons having ordinary skill in the art that products that are currently available in the market, which attempt lifetime value or ROI, require additional components or that necessary information be manually inputted. Such required information includes, but is not limited to: the cost input by the user or information programmatically sent to a system via the Application Programming Interface (API); links built inside of a system; and/or, revenue input by the user or programmatically sent to a system via API, or, a Uniform Resource Locator (URL) sending information back to a tracking system indicating a sale occurred. The present invention further differs from existing products as no conversion program or tracking program needs to be installed on the user's browser. Time and date are not collected as secondary information, but rather such information to be used to compare click time and click date. Additionally, in the present invention cookies are not used or relied upon to track information. Rather, email addresses are detected and inserted into a central database when inputted into a web browser by the contact. Email addresses also are not stored locally on the device. The present process requires no relating of the link click by any server, unlike existing processes that have such a requirement. Furthermore, the process is substantially less complex than existing processes. Users can create tracking links quickly and easily without centralized link storage or creation. There is no contact-specific information included in the link, and the present invention does not require link clicks to determine when certain actions happen other than the ad click. A specific thank you page does not need to be visited in order to be tracked, nor do contacts need to subscribe or be manually entered on behalf of a contact. Rather the present invention tracks product purchases back to the contact's ad clicks, social clicks, and/or email clicks. There are no requirements of user interactions other than an email input at any time after an ad click. Tracking information is also not added to a contact's device. Instead, the process grabs and stores tracking info in the centralized database when a link click of interest is clicked. Unlike prior processes or systems, one focus of this process is to measure the results of advertising.

A more detailed explanation of the present invention, showing its advantages over the prior method is provided in the following description and claims and is illustrated in the accompanying drawings.

### BRIEF DESCRIPTION OF THE DRAWINGS

FIG. 1 is a flow chart showing schematically, the steps of the present invention;

FIG. 2 is a schematic representation of the information required to use the present invention;

FIG. 3 is a screen shot of a web page, showing from where some specific information is gleaned by the invention;

FIG. 4 is a screen shot of a web page, showing from where client information entered is taken for use in the present invention;

FIG. 5 is a representation of a record created by the invention based on information secured from the web page;

FIG. 6 is a multipage schematic of calculations made by the invention;

FIG. 7 is a schematic representation of a tracking customer return visits to web site as compared to the original visit;

FIG. 8 is a schematic representation of the invention process of tracking and noting links;

FIG. 9 is a representation of a Linkedin® web page of the type used in the present invention;

FIG. 10 is a web page showing a report link;

FIG. 11 is a sample report of return on investment (ROI);

FIG. 12 is a Facebook® web page reporting a link;

FIG. 13 is a sample report of social media ROI

FIG. 14 is a Twitter® web page reporting a link;

FIG. 15 is a sample report of social media ROI

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

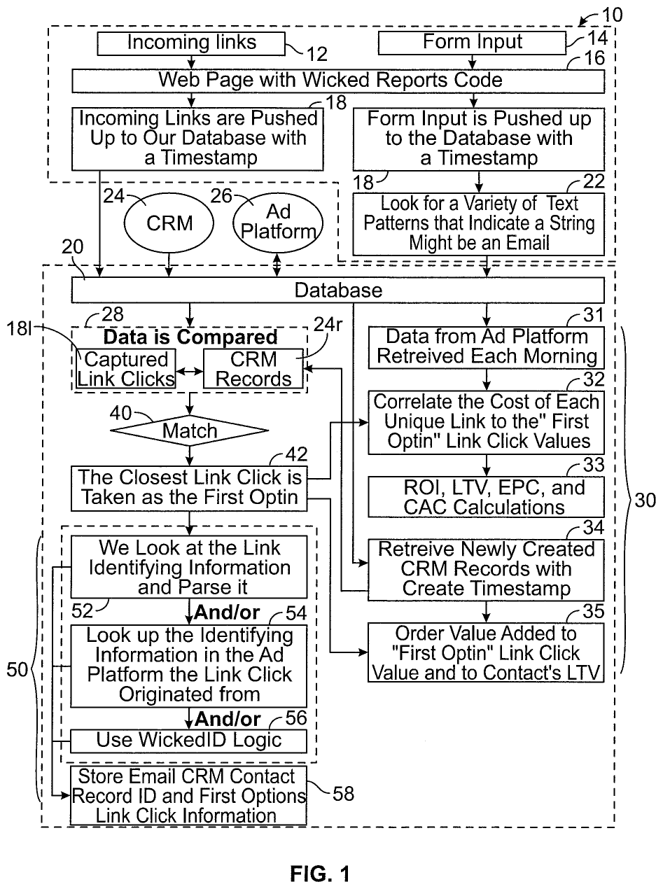

As shown in FIG. 1, the present invention provides a solution to easily, accurately, and actionably determine where the highest value customers came from, and whether those customers were acquired profitably. Such must include a means to measure the value that the customer brings starting from the customer's first entry, or “opt-in”, to the website and the path that the customer has followed and is expected to take in the future. More specifically, the first time a customer comes to a website is its “first click” on the site; the first time a potential customer becomes known to a business, other than through tracking schemes such as “cookies”, is when that potential customer joins the website's email list and becomes a lead, which the present invention refers to as “first optin”.

FIG. 1 is a flow chart representation of the system 10 of the present invention. In the use of web page, a customer will enter data onto the web page, which will then be used by the system 10. It will be noted that the term Wicked Reports™ is shown as a part of the process. Wicked Reports™ is a marketing analysis company that provides subscription based actionable reports on marketing results. Persons having ordinary skill in the art will recognize that this company is being used in the present application as a model for the types of reports that are needed by the method, but that any such report provided by any provider or created by the user of the method, can be substituted without departing from the novel scope of the present invention. While Wicked Reports™ are used herein, the term “reports” on its own may be substituted in the description to indicate that other types of reports can be used instead.

Referring to FIG. 1, method 10 includes the steps of either permitting links 12 or forms 14 to be entered by a customer and then sent to a web page 16 of the user, where report codes (such as Wicked Reports™ codes) are added to the link or form and pushed up 18 to the user's database. In the case of a link 12, the link comprises a timestamp and is put into database 20 automatically. For forms 14, the method 10 includes the step of reviewing the form 22 to find specific patterns thereon to determine an email address, prior to placing the form into database 20. It will be seen that such items as Customer Relationship Manager (CRM) 24 and the Ad Platform 26 are included in the database 20 (and that in the use of the methods, the database 20 and ad platform 26 work to update each other in order to remain current) in the preferred embodiment of the present invention. Data entered into database 20 is immediately compared 28 to records 24r in the CRM 24; the results of the comparison 28 will be discussed in detail below. Simultaneously, the method 10 does a number of maintenance steps 30 relative to the database, namely, the method retrieves data 31 from Ad Platform 26 every morning. It will be understood by persons having ordinary skill in the art that data can be retrieved more or less often than noted without departing from the novel scope of the present invention; an indication of time is included here as a suggestion only. The steps of this part 30 of the method will be described herein but will made more clear upon the review of the steps being simultaneously performed by the method. In retrieving data from the Ad Platform 26, cost data is secured and used to match up with the data captured from the links. The method 10 then correlates 32 the costs of each unique link to a first link, and/or the “First Optin” link values stored; the method 10 calculates 33 any number of metrics including, but not limited to, Return On Investment (ROI), Customer Lifetime Value (LTV), Electronic Product Code (EPC) and Customer Acquisition Costs (CAC). The method can also retrieve 34 any newly created CRM records, those having been created since the last retrieval of data 31 and can immediately add such to the CRM records 24r for data comparison 28 with captured links 181. The method 10 then updates 35 the “First Optin” link to update its order values.

As noted, while steps 30 are being completed, the method 10 also takes the steps of comparing 28, the newly captured data 181 to the CRM records 24r in database 20. If a match 40 is found, the closest link in time is then taken 42 as the “First Optin”; the method can then both add this data to the correlation of cost 32 and update the order value 35, thereof. It will be understood that various additional steps 50 to determine the link identification information can be taken to increase the value of the data collected, including but not limited to: parsing 52 the link identification information; look up 54 identifying information from where the link originated; applying programmed logic, such as from WickedID Logic™ (or other sources as may be desired, and known to persons having ordinary skill in the art); all such steps and the resulting data such as email addresses, CRM, contact record ID and first optins, including steps and data not noted here but known to persons having ordinary skill in the art, are then stored 58 for further use in method 10.

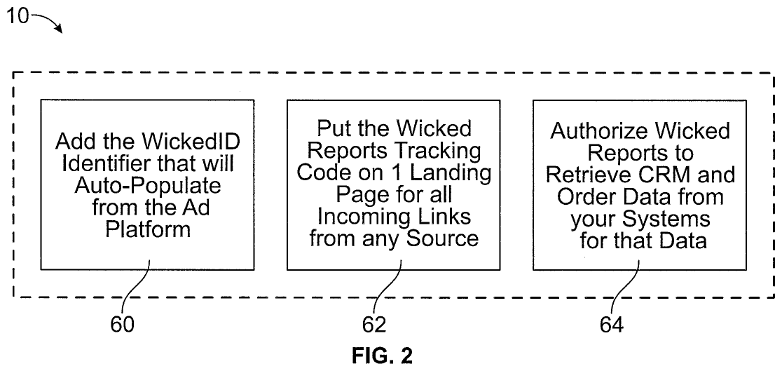

As shown in FIG. 2, in the method 10 of the present invention only three steps are required, as opposed to the complex process of prior methods (as noted in the Background above). First, the invention identifier must be added 60 to auto-populate the ad platform. In the present invention this is done automatically by the use of a third party system, as explained below. Second, the identification tracking code must be added 62 to one landing page for all incoming links from any source. Third, the invention must be authorized 64 to retrieve CRM and order data from third party systems. In the illustrative embodiment the third party system noted is Wicked Reports™. By using the present invention, users can identify the compelling factor behind its customer's choice to join the CRM email list. This information likewise provides insight as to where and how more customers can be targeted, in the event that future purchases are made. The following details, illustrated with sample web pages and reports, set out to explain the process in detail.

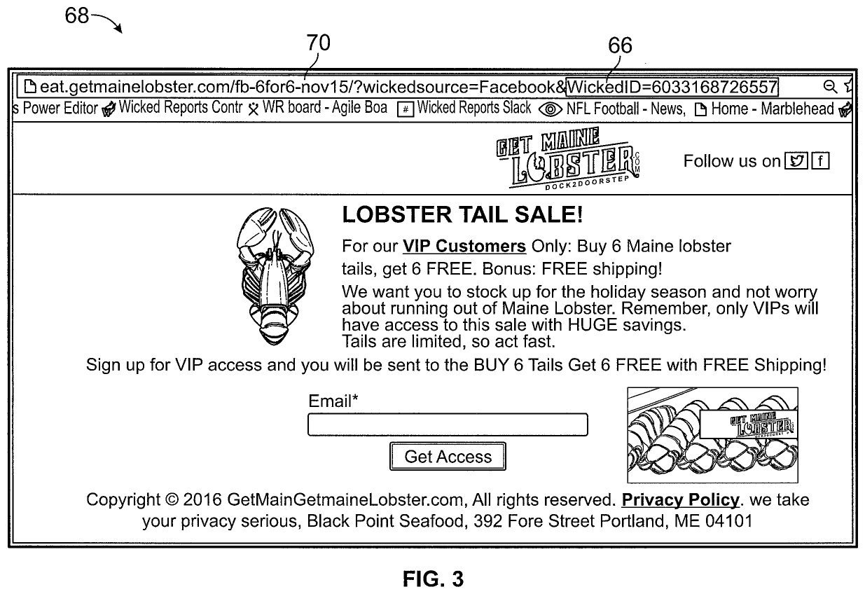

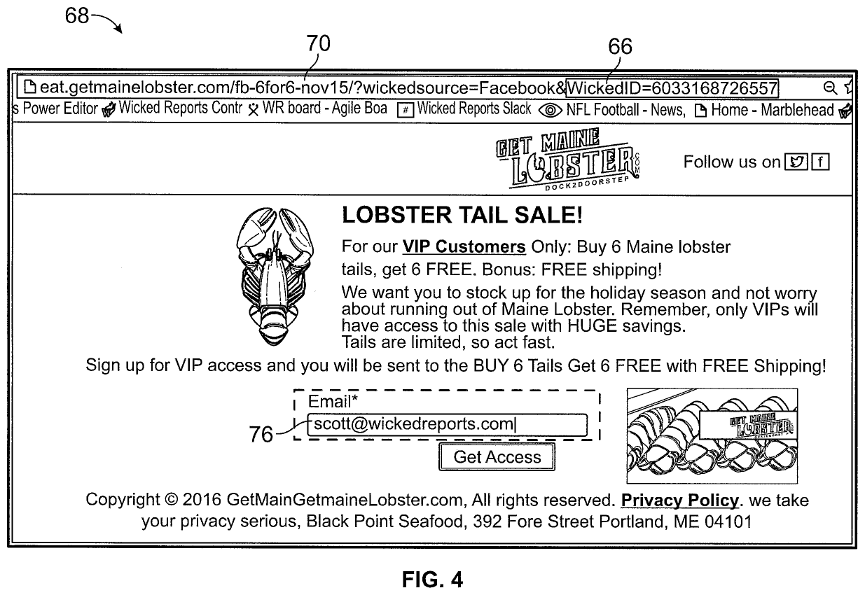

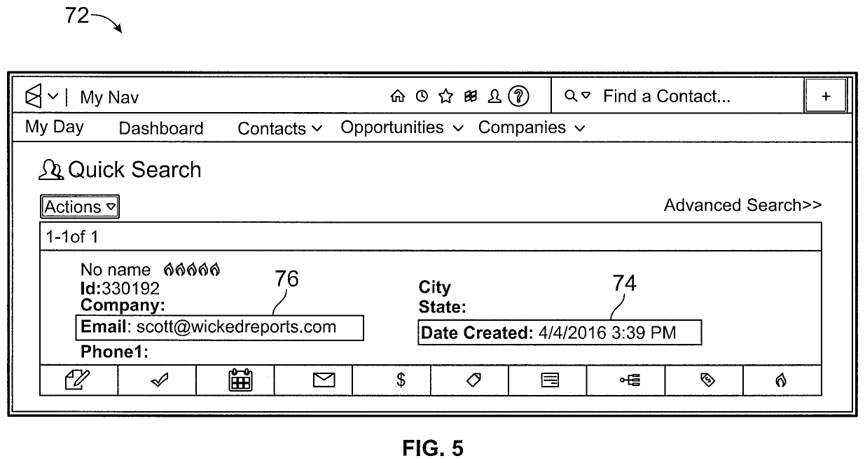

As shown below in FIGS. 3 and 4, a specific code 66 sits on a web page 68 to detect incoming links. The incoming links 70 are then immediately pushed up to a main database 20 with a timestamp 74 (see FIG. 5). The specific code 66 detects any form input and then pushes that input immediately up to the invention database 20 with a timestamp 74. In the preferred embodiment, billing information can be is omitted. As shown in FIG. 4, email addresses 76 are one example of a desirable input or data point. The present invention scans 22 the inputs and looks for a variety of text patterns which could indicate that a data point may be an email address, or other patterns as may be desired and used as recognized by persons having ordinary skill in the art.

All newly created CRM records 24r, along with the timestamps 74 are retrieved daily (or as often as needed or programmed by the user), as shown in FIG. 5. Referring to FIGS. 1 and 5, all captured link click times 181 that have email address 76 information are compared against all CRM creation records 24r that match the email address information captured. When a match 40 of email address is found between the link clicks captured 181 and the new CRM records 24r, the closest link click 42 in time is determined. This process is also known as the “first optin”. For purposes of simplicity, the “first optin” can be thought of as “the link click that compelled a website visitor to join a user's CRM list for future marketing”. The present invention also allows users to define how far back in time to look in the main link click capture database for “first optin” clicks.

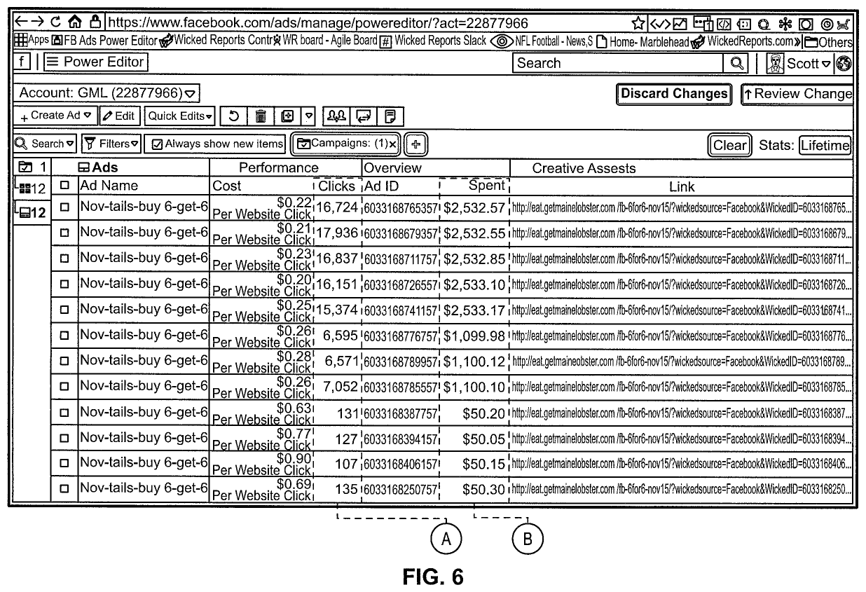

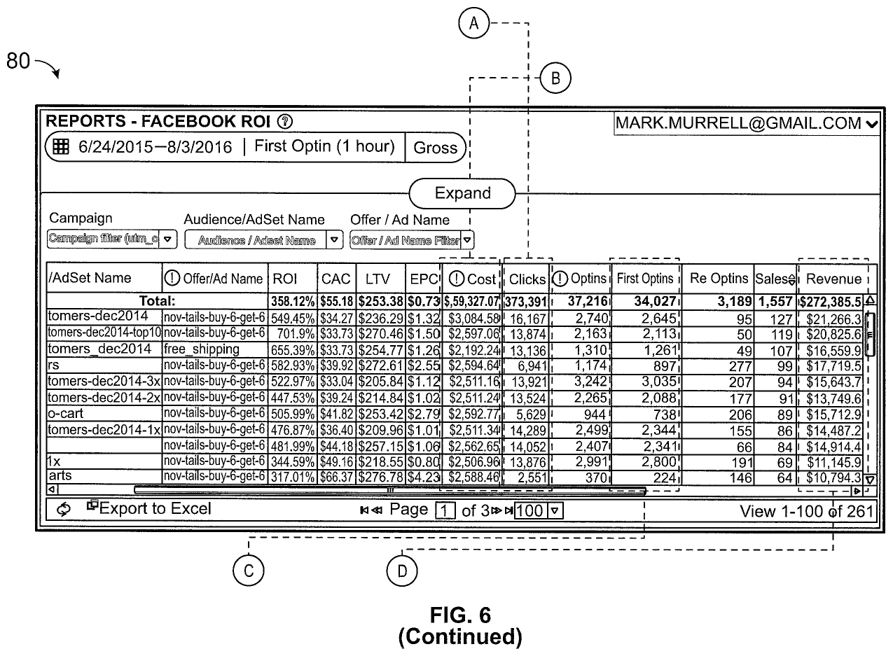

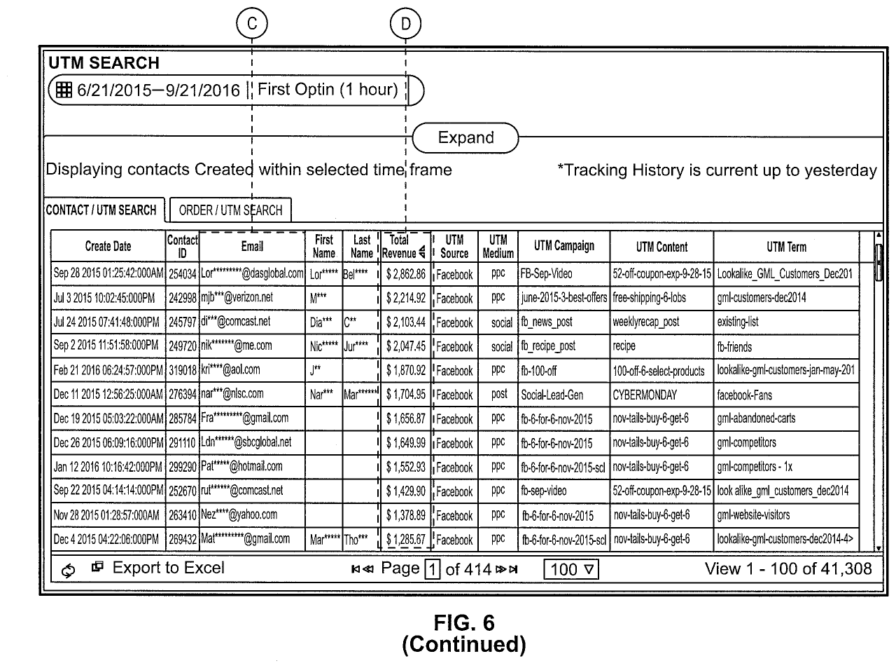

Once the “first optin” link click 42 is found, the method 10 can determine the link identifying information 50, which will then be parsed 52. It can also determine the identifying information in the ad platform 54 the link click originated from. In addition, it can determine the proprietary logic 56 that is explained in further detail below. Once this information is identified, the invention stores 58 the email address, CRM contact record ID, and the “first optin” link click information. All newly created order records with the timestamps are retrieved 31, in the illustrative example, daily, along with all ad platform data. The order values are then added to the “first optin” link click value and to the contact's lifetime value. The cost of each unique link click is correlated with the “first optin” link click values and all ROI, LTV, EPC, and CAC values are calculated 80, as shown in FIG. 6.

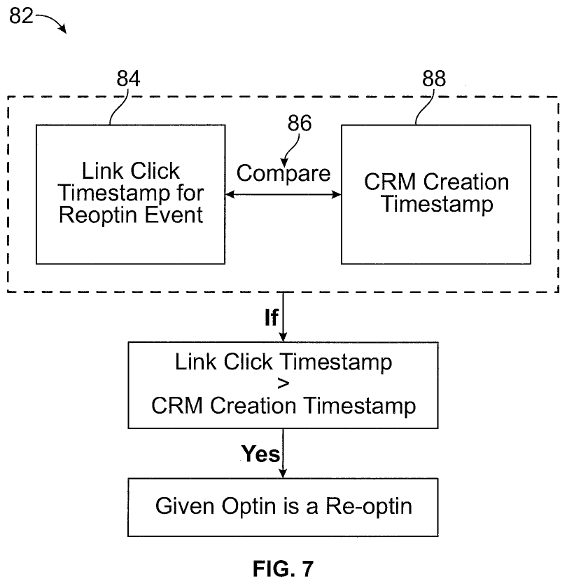

Referring now to FIG. 7, when a contact makes a subsequent visit or purchase to the web site or original link, that link can be described as a “re-optin”. Re-optin tracking, then, describes the association of a purchase to a “re-optin event” and does so, in the present invention without pixels, post purchase customer actions, or post purchase specific page loads of prior methods, by using instead the email address detected in an incoming link click, the date and time of the link click, the date and time of the CRM record creation, the email address detected when input on a web page, and the email address of a future purchase when detected.

In today's digital world, retargeting existing marketing leads and customers has become a very important strategy. In an effort to increase engagement and convert more sales, there are number of retargeting strategies that advertisers use. For instance, advertisers upload email lists to ad platforms and then retarget them with ads. Advertisers also continue to email those leads to nurture the relationship. Marketers employing retargeting strategies need to know “what was the last offer that compelled someone already on its email list to give out their email address again?” This is because often there are emails and ads that go to landing pages for new “lead magnets”, such as offers, webinars, pdfs, or online courses. These new “lead magnets” require an email address optin so that the content can be delivered and consumed. When a lead or previous customer indicates interest by “re-optin” from a specific link, for a specific lead magnet, and then makes a purchase after that “re-optin” event, it indicates that the offers, webinars, pdfs, or online courses are effective at getting people converted to customers that were already on the user's email list.

Existing tracking and ROI solutions look at the last click before a purchase. The idea is that the very last click detected is what convinced the customer to finally buy. There is no “reoptin” tracking process, as offered by the present invention.

The process involved in re-optin tracking 82 is similar to the optin tracking process 10, described above. There is however, one key difference, as shown in FIG. 7, the link click timestamp 84 for the re-optin event is compared 86 to the CRM creation timestamp 88. If the re-optin link click timestamp 84 is later than the CRM creation timestamp 88, then the process can automatically detect that the optin was not for a new, “first optin” lead, but instead is a “re-optin” lead.

Identifying Incoming Links Automatically 90, is the third part of the present process and describes the ability to add identifying tracking information to a link without the need to first store the link identification information into a centralized database. Links can be combined, or discarded, or rephrased as needed. While there are existing processes to identify links, such processes are convoluted and highly technical. Additionally, when using existing processes, users consistently create typos, use incorrect values or characters, or forget tracking parameters. The results from said existing processes often lead to bad data, time waste, a lack of link attribution, frustration, and anger.

The present invention solves the above issues by allowing users to easily and quickly add tracking and identifying information to a link while sharing and/or promoting the link. Additionally, the present invention includes memory means and is able to keep the level of detail that the invention's ad tracking link provides. Such detail is critical as it allows advertisers to make fair and accurate comparisons between the results. Moreover, the present process functions without the need to first create a link in a central data store.

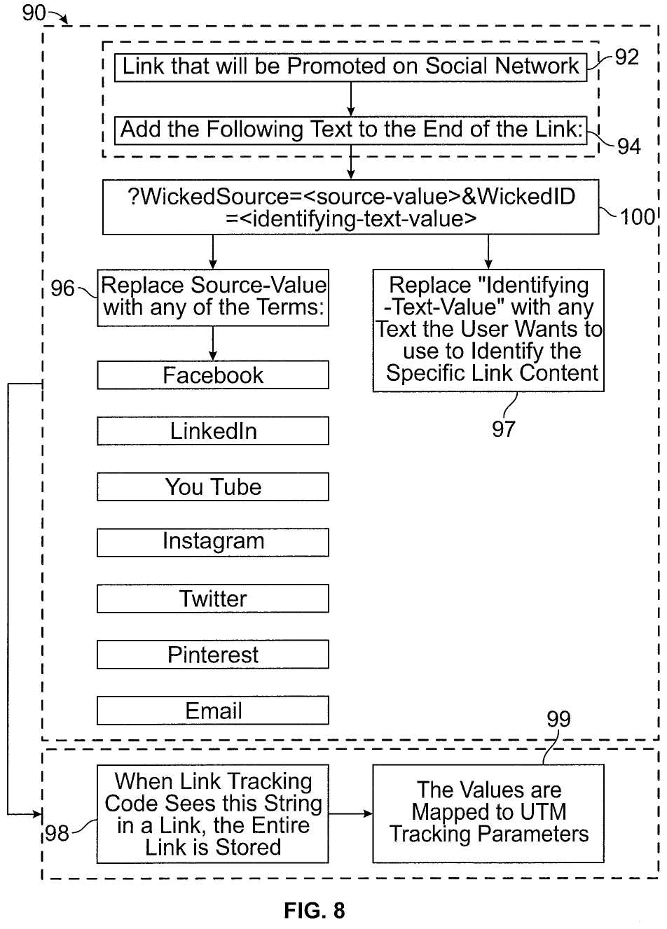

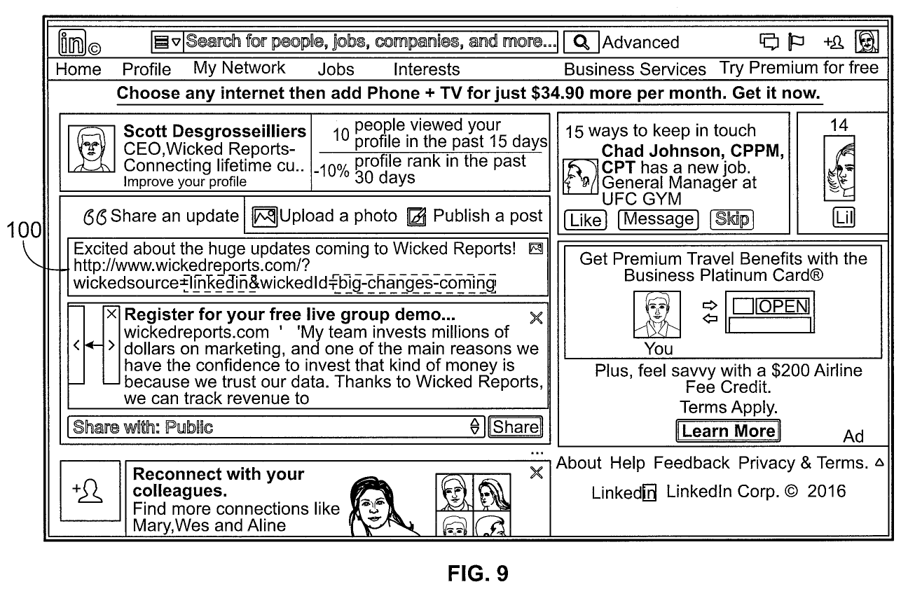

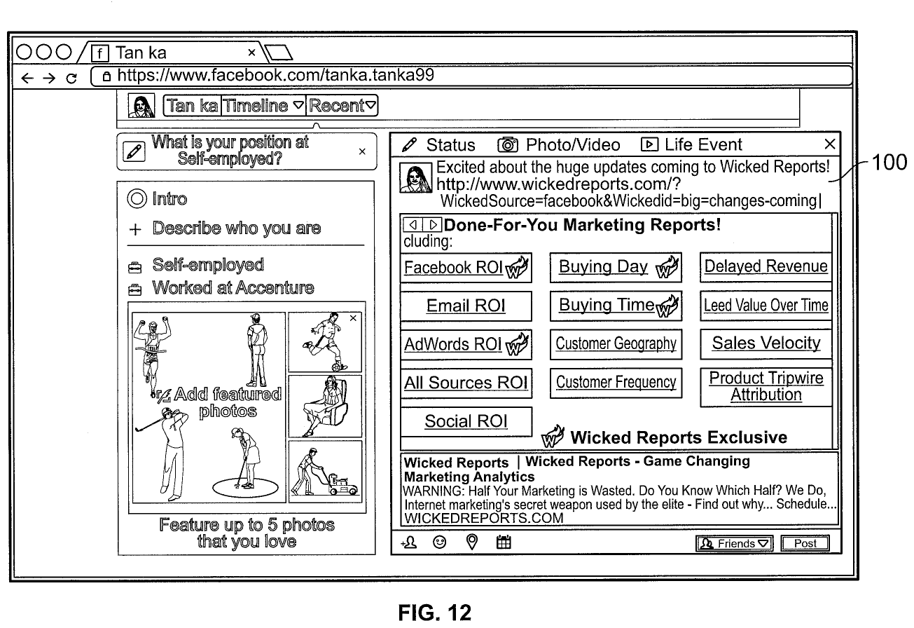

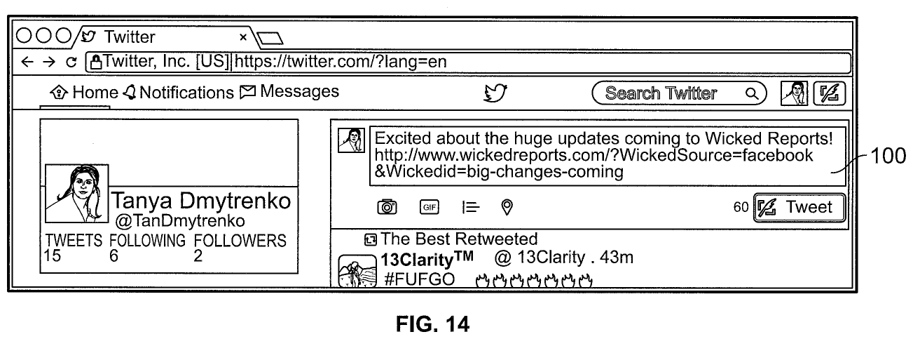

The complete process of identifying links automatically can be described as follows and is shown in FIG. 8. Once the user has identified a link to share and/or promote 92, the user must add the following text to the end of the associate web link 94: ?WickedSource=<source-value>&WickedID=<identifying-text-value>. This step is demonstrated 100 on a LinkedIn page in FIG. 9, on a Facebook page in FIG. 12, and a Twitter page in FIG. 14.

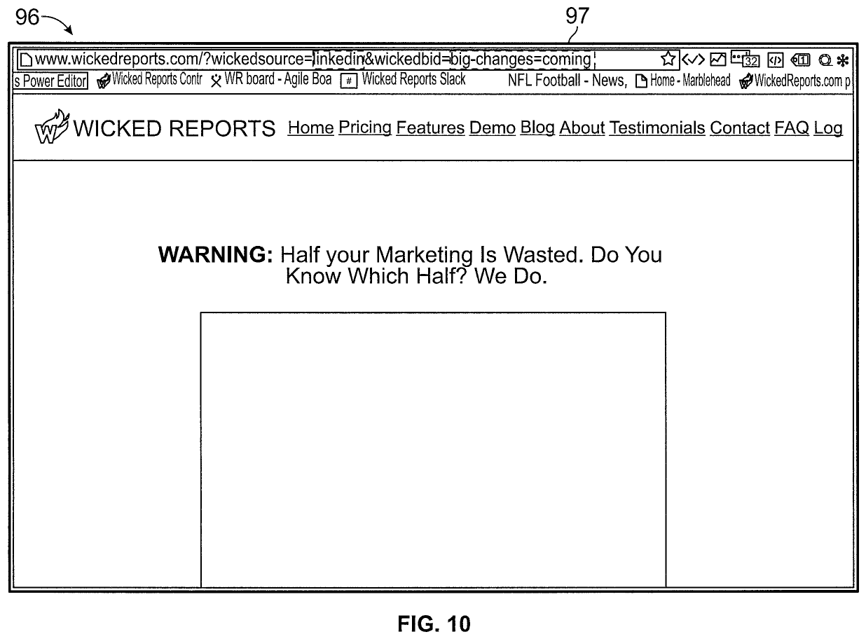

Next, the user replaces 96 the <source-value> with any of these terms: Facebook, LinkedIn, YouTube, Instagram, Twitter, Pinterest, Email and replaces 97 <identifyingtext-value> with any text the user wants to use to identify the specific link content. This step is best demonstrated in FIG. 10. When the invention link tracking code sees this string in a link 98, the invention stores the entire link. Next, the process maps the values to Urchin Tracking Module (UTM) tracking parameters 99. This allows social and organic posting, done with the present invention identification, to be able to match up to advertising, across five dimensions.

For example, the link

?WickedSource=Facebook&WickedID=Scotts-great-blog-post is turned into the following link information:

Utm_source=Facebook Utm_medium=post Utm_campaign=social-lead-gen

Utm_content=scotts-great-blog-post Utm_term=facebook-fans.

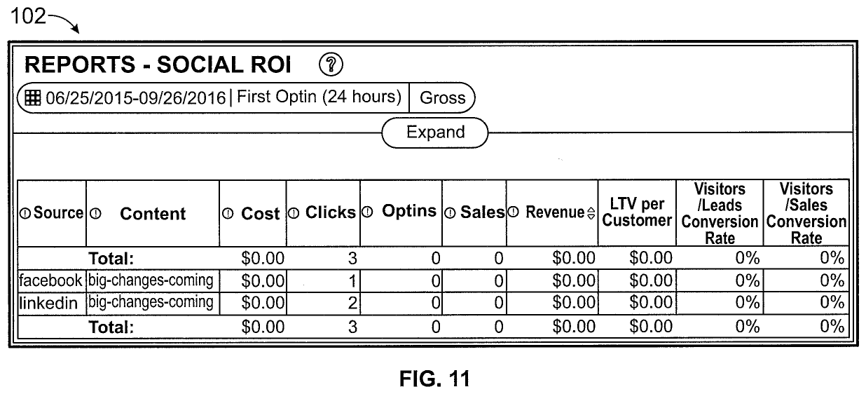

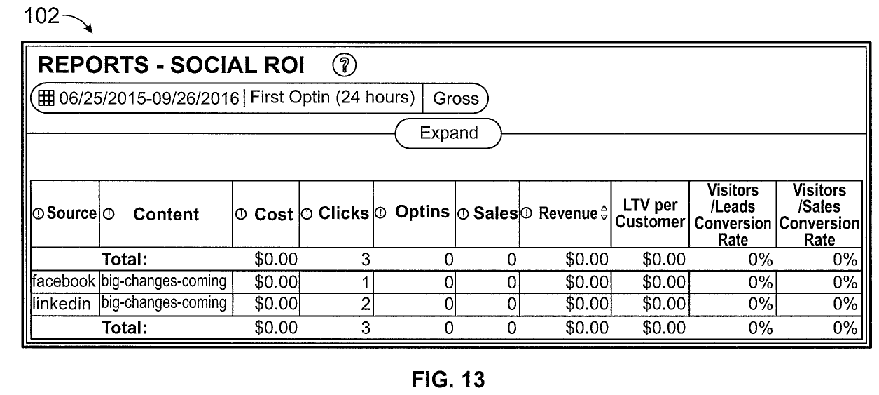

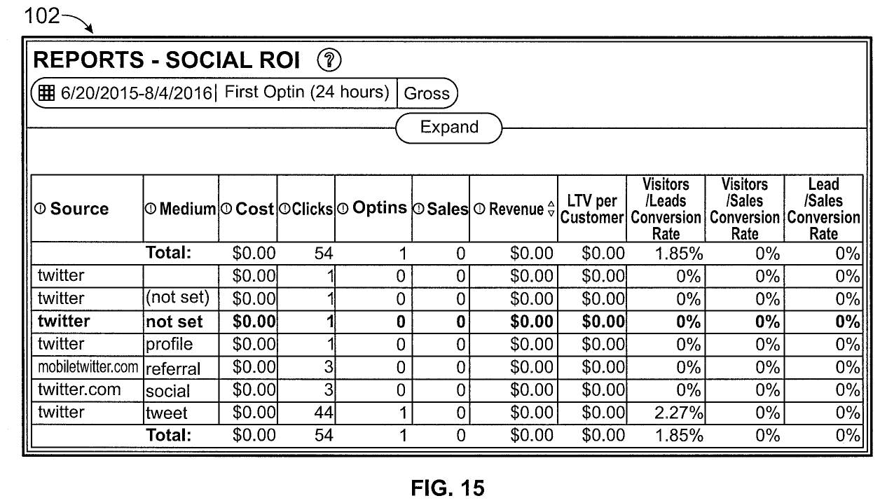

It will be seen that this process largely benefits the end user of the method, as rather than having to learn, understand, and remember to create links in another database, and correctly pick the accurate link tracking values to insure maximum insights and actions when the data is aggregated, the end user must only use the easy to remember text string whenever posting a social link. The end user then has ROI metrics 102 on organic social posts, see FIGS. 11, 13 and 15.

First optin and re-optin tracking processes described above are also used, but tied to organic social posts, using this quick, easy, and memorable mechanism. “Utm_term mapping” means that the correct social audience is identified. This information can then be compared against the ad audiences of other collected link clicks, to see if the organic fan base is more or less valuable than the targeted ad audience, as shown in FIGS. 11, 13, and 15. Utm_campaign mapping of “social-lead-gen” captures the audience intent automatically. Accordingly, gathering accurate data with this process is simple and complete with minimal effort.

Specific embodiments of novel methods and apparatus for construction of the Tracking Lifetime Customer Value by Email & IP and Method for Same according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

Although an illustrative embodiment of the invention has been shown and described, it is to be understood that various modifications and substitutions may be made by those skilled in the art without departing from the novel spirit and scope of the invention.

1.-24. (canceled)

25. A method of providing a web page owner with an identification of an advertisement of a plurality of advertisements that caused a potential lead to visit a web page and determining whether the potential lead is a new lead (‘first optin’) or a re-engaged, existing lead (‘re-optin’), the method comprising:
implementing a link tracking identifier script in the plurality of advertisements that directs a potential lead to a web page hosted by a web page owner, the link tracking identifier script constructed and arranged to provide, to a central database, an advertisement identifier, a time stamp, and a link tracking identifier of the potential lead;
implementing a form in the web page hosted by the web page owner, the form constructed and arranged to receive an email address that is input to the form by the potential lead and to provide the email address and a form time at which the email address is entered into the form to the central database;
correlating the email address with the link tracking identifier for the potential lead and identifying a last prior time stamp associated with the last prior visit to the advertisement by the potential lead to identify the advertisement of the plurality of advertisements that caused the potential lead to visit the web page; and
accessing a customer relations manager database of the web page owner to identify a CRM timestamp at which the email address was first input into the customer relations manager database as a lead;
comparing the form time and the CRM timestamp in order to:
identify the potential lead as a new lead (‘first optin’) when the form time is before the CRM timestamp; and
identify the potential lead as a reengaged lead (‘re-optin’) when the form time is after the CRM timestamp; and
providing the web page owner with the identification of the advertisement that caused the potential lead to input the email address into the form and whether the lead is a new lead (first optin) or a re-engaged lead (re-optin).

26. The method of claim 25, further comprising:
accessing sales revenue data for the lead and cost data for the advertisement that caused the lead to input the email address into the form;
calculating a return on investment for the advertisement that caused the lead to input the email address into the form by comparing the revenue data and the cost data.

27. The method of claim 25, further comprising:
accessing sales revenue data for the lead including times at which the lead has made purchases from the web page owner;
calculating a customer lifetime value for the advertisement that caused the lead to input the email address into the form by comparing the revenue data and the times at which the lead made purchases from the web page owner.

28. The method of claim 25, further comprising:
accessing cost data for the advertisement that caused the lead to input the email address into the form;
determining how many leads input the email address into the form;
calculating customer acquisition costs by comparing the cost data and how many leads input the email address into the form.

29. The method of claim 25, further comprising:
accessing cost data for the advertisement that caused the lead to input the email address into the form;
accessing sales revenue data for leads that input the email address into the form;
determining, from the sales revenue data, a number of leads that eventually made purchases from the web page owner; and
calculating customer acquisition costs by comparing the number of the leads that eventually made purchases from the web page owner and the cost data.

30. The method of claim 25, wherein the method is completed automatically in a computer.
